(19) United States
(12) Patent Application Publication
(10) Pub. No.: US 2010/0009308 A1
(43) Pub. Date: Jan. 14, 2010

(54) Visualizing and Manipulating Digital Models for Dental Treatment

(75) Inventors: Huafeng Wen, Redwood City, CA (US); Muhammad Ziaullah Khan Chishti, Washington, DC (US); Yasser Bashir, Lahore (PK); Omair Aslam, Lahore Cantt (PK); Sohaib Athar, Lahore Cantt (PK)

Correspondence Address: PAUL HASTINGS JANOFSKY & WALKER LLP, 3579 VALLEY CENTRE DRIVE, SAN DIEGO, CA, 92130, US

(73) Assignee: ALIGN TECHNOLOGY, INC., Santa Clara, CA (US)

(21) Appl. No.: 11/744,823

(22) Filed: May 4, 2007

Related U.S. Application Data
(60) Provisional application No. 60/798,237, filed on May 5, 2006.

(51) Int. Cl. A61C 7/00; G06T 15/00; G06F 17/50; G05B 19/18

(52) U.S. Cl. 433/24; 345/419; 700/98; 345/651; 345/156; 345/168; 703/1; 700/118

(57) ABSTRACT

Methods and apparatus for visualizing and manipulating three-dimensional digital dental models and related methods and apparatus for dental treatments are disclosed. In one aspect, a method for visualizing and manipulating a three-dimensional digital dental model may comprise viewing the three-dimensional digital dental model and using hand gestures to instruct a computer to manipulate one or more teeth in the digital dental model. In other aspects, a dental treatment method may comprise viewing a three-dimensional digital model, using hand gestures, a conventional keyboard, and/or a conventional mouse to instruct a computer to manipulate one or more teeth in the digital model to generate a three-dimensional digital model of a modified arrangement of the subject's teeth, and fabricating one or more dental aligners configured to reposition the subject's teeth into the modified arrangement. Viewing may comprise stereoscopically viewing a digital dental model.

### CROSS-REFERENCE TO RELATED APPLICATIONS

The present application claims the benefit of U.S. Provisional Application Ser. No. 60/798,237, filed May 5, 2006, which is incorporated herein by reference in its entirety.

### TECHNICAL FIELD

This application generally relates to the field of dental care, and more particularly to the field of orthodontics.

### BACKGROUND

Orthodontics is the practice of manipulating a subject's teeth to provide better function and appearance. Typically, brackets are bonded to a subject's teeth and coupled together with an arched wire. The combination of the brackets and wire provide a force on the teeth causing them to move. Once the teeth have moved to a desired location and are held in place for a certain period of time, the body adapts bone and the surrounding soft-tissue to maintain the teeth in the desired location. To further assist in retaining the teeth in the desired location, a subject may be fitted with a retainer.

To achieve tooth movement, orthodontists utilize their expertise to first determine a three-dimensional mental image of the subject's physical orthodontic structure and a three-dimensional mental image of a desired physical orthodontic structure for the subject, which may be assisted through the use of X-rays and/or models. Based on these mental images, the orthodontist further relies on his/her expertise to place the brackets and/or bands on the teeth and to manually bend (i.e., shape) wire, such that a force is asserted on the teeth to reposition the teeth into the desired physical orthodontic structure. As the teeth move towards the desired location, the orthodontist makes continual judgments as to the progress of the treatment, plans next steps in the treatment (e.g., determines new bends in the wire, repositions or replaces brackets, decides whether a head gear is required, etc.), and evaluates the success of the previous steps.

In general, the orthodontist makes manual adjustments to the wire and/or replaces or repositions brackets based on his or her expert opinion. Unfortunately, in the oral environment, it is difficult for a human being to accurately develop a visual three-dimensional image of an orthodontic structure due to the limitations of human sight and the physical structure of a human mouth. In addition, it is difficult to accurately estimate three-dimensional wire bends (with accuracy within a few degrees) and to manually apply such bends to a wire. Further, it is hard to determine an ideal bracket location to achieve the desired orthodontic structure based on the mental images. It is also extremely difficult to manually place brackets in what is estimated to be the ideal location. Accordingly, orthodontic treatment is an iterative process requiring multiple wire changes, with the process success and speed being very much dependent on the orthodontist's motor skills and diagnostic expertise. As a result of multiple wire changes, subject discomfort and cost are increased. As one would expect, the quality of care varies greatly from orthodontist to orthodontist as does the amount of time required to treat a subject.

Over the years, various methods and devices have been developed to assist dentists with delivery of orthodontic treatments. Examples of these methods and devices are disclosed in U.S. Pat. No. 6,699,037 B2 titled “METHOD AND SYSTEM FOR INCREMENTALLY MOVING TEETH” issued to Chishti et al., dated Mar. 2, 2004; U.S. Pat. No. 6,682,346 B2 titled “DEFINING TOOTH-MOVING APPLIANCES COMPUTATIONALLY” issued to Chishti et al., dated Jan. 27, 2004; U.S. Pat. No. 6,471,511 titled “DEFINING TOOTH-MOVING APPLIANCES COMPUTATIONALLY” issued to Chishti et al., dated Oct. 29, 2002; U.S. Pat. No. 5,645,421 titled “ORTHODONTIC APPLIANCE DEBONDER” issued to Slootsky, dated Jul. 8, 1997; U.S. Pat. No. 5,618,176 titled “ORTHODONTIC BRACKET AND LIGATURE AND METHOD OF LIGATING ARCH WIRE TO BRACKET” issued to Andreiko et al., dated Apr. 8, 1997; U.S. Pat. No. 5,607,305 titled “PROCESS AND DEVICE FOR PRODUCTION OF THREE-DIMENSIONAL DENTAL BODIES” issued to Andersson et al., dated Mar. 4, 1997; U.S. Pat. No. 5,605,459 titled “METHOD OF AND APPARATUS FOR MAKING A DENTAL SET-UP MODEL” issued to Kuroda et al., dated Feb. 25, 1997; U.S. Pat. No. 5,587,912 titled “COMPUTER AIDED PROCESSING OF THREE-DIMENSIONAL OBJECT AND APPARATUS THEREFOR” issued to Andersson et al., dated Dec. 24, 1996; U.S. Pat. No. 5,549,476 titled “METHOD FOR MAKING DENTAL RESTORATIONS AND THE DENTAL RESTORATION MADE THEREBY” issued to Stern, dated Aug. 27, 1996; U.S. Pat. No. 5,533,895 titled “ORTHODONTIC APPLIANCE AND GROUP STANDARDIZED BRACKETS THEREFOR AND METHODS OF MAKING, ASSEMBLING AND USING APPLIANCE TO STRAIGHTEN TEETH” issued to Andreiko et al., dated Jul. 9, 1996; U.S. Pat. No. 5,518,397 titled “METHOD OF FORMING AN ORTHODONTIC BRACE” issued to Andreiko et al., dated May 21, 1996; U.S. Pat. No. 5,474,448 titled “LOW PROFILE ORTHODONTIC APPLIANCE” issued to Andreiko et al., dated Dec. 12, 1995; U.S. Pat. No. 5,454,717 titled “CUSTOM ORTHODONTIC BRACKETS AND BRACKET FORMING METHOD AND APPARATUS” issued to Andreiko et al., dated Oct. 3, 1995; U.S. Pat. No. 5,452,219 titled “METHOD OF MAKING A TOOTH MOLD” issued to Dehoff et al., dated Sep. 19, 1995; U.S. Pat. No. 5,447,432 titled “CUSTOM ORTHODONTIC ARCHWIRE FORMING METHOD AND APPARATUS” issued to Andreiko et al., dated Sep. 5, 1995; U.S. Pat. No. 5,431,562 titled “METHOD AND APPARATUS FOR DESIGNING AND FORMING A CUSTOM ORTHODONTIC APPLIANCE AND FOR STRAIGHTENING OF TEETH THEREWITH” issued to Andreiko et al., dated Jul. 11, 1995; U.S. Pat. No. 5,395,238 titled “METHOD OF FORMING ORTHODONTIC BRACE” issued to Andreiko et al., dated Mar. 7, 1995; U.S. Pat. No. 5,382,164 titled “METHOD FOR MAKING DENTAL RESTORATIONS AND THE DENTAL RESTORATIONS MADE THEREBY” issued to Stern, dated Jan. 17, 1995; U.S. Pat. No. 5,368,478 titled “METHOD FOR FORMING JIGS FOR CUSTOM PLACEMENT OF ORTHODONTIC APPLIANCES ON TEETH” issued to Andreiko et al, dated Nov. 29, 1994; U.S. Pat. No. 5,342,202 titled “METHOD FOR MODELING CRANIO-FACIAL ARCHITECTURE” issued to Deshayes, dated Aug. 30, 1994; U.S. Pat. No. 5,340,309 titled “APPARATUS AND METHOD FOR RECORDING JAW MOTION” issued to Robertson, dated Aug. 23, 1994; U.S. Pat. No. 5,338,198 titled “DENTAL MODELING SIMULATOR” issued to Wu et al., dated Aug. 16, 1994; U.S. Pat. No. 5,273,429 titled “METHOD AND APPARATUS FOR MODELING A DENTAL PROSTHESIS” issued to Rekow et al., dated Dec. 28, 1993; U.S. Pat. No. 5,186,623 titled “ORTHODONTIC FINISHING POSITIONER AND METHOD OF CONSTRUCTION” issued to Breads et al., dated Feb. 16, 1993; U.S. Pat. No. 5,139,419 titled “METHOD OF FORMING AN ORTHODONTIC BRACE” issued to Andreiko et al., dated Aug. 18, 1992; U.S. Pat. No. 5,059,118 titled “ORTHODONTIC FINISHING POSITIONER AND METHOD OF CONSTRUCTION” issued to Breads et al., dated Oct. 22, 1991; U.S. Pat. No. 5,055,039 titled “ORTHODONTIC POSITIONER AND METHODS OF MAKING AND USING SAME” issued to Abbatte et al., dated Oct. 8, 1991; U.S. Pat. No. 5,035,613 titled “ORTHODONTIC FINISHING POSITIONER AND METHOD OF CONSTRUCTION” issued to Breads et al., dated Jul. 30, 1991; U.S. Pat. No. 5,011,405 titled “METHOD FOR DETERMINING ORTHODONTIC BRACKET PLACEMENT” issued to Lemchen, dated Apr. 30, 1991; U.S. Pat. No. 4,936,862 titled “METHOD OF DESIGNING AND MANUFACTURING A HUMAN JOINT PROSTHESIS” issued to Walker et al., date Jun. 26, 1990; U.S. Pat. No. 4,856,991 titled “ORTHODONTIC FINISHING POSITIONER AND METHOD OF CONSTRUCTION” issued to Breades et al., dated August 15, 1989; U.S. Pat. No. 4,798,534 titled “METHOD OF MAKING A DENTAL APPLIANCE” issued to Breads, dated Jan. 17, 1989; U.S. Pat. No. 4,755,139 titled “ORTHODONTIC ANCHOR APPLIANCE AND METHOD FOR TEETH POSITIONING AND METHOD OF CONSTRUCTING THE APPLIANCE” issued to Abbatte et al., dated Jul. 5, 1988; U.S. Pat. No. 3,860,803 titled “AUTOMATIC METHOD AND APPARATUS FOR FABRICATING PROGRESSIVE DIES” issued to Levine, dated Jan. 14, 1975; U.S. Pat. No. 3,660,900 titled “METHOD AND APPARATUS FOR IMPROVED ORTHODONTIC BRACKET AND ARCH WIRE TECHNIQUE” issued to Andrews, dated May 9, 1972; each of which is incorporated herein by reference in its entirety for all purposes.

The practice of orthodontics and other dental treatments can benefit from a computer model that is representative of the positions of the teeth in a tooth arch. The computer model may be prepared based on an impression model taken from the subject. The computer model may be utilized to assist the dentist in planning an orthodontic treatment regimen by providing visual feedback of possible treatment steps in a particular treatment regimen.

In particular, the computer modeling tool may be useful in designing and manufacturing removable aligning appliances for orthodontic treatment. In some existing systems, a digital model of the initial arrangement of a subject's teeth is generated from information captured from an impression model of the subject's dentition. A computer is then used to manipulate the digital model of the initial arrangement to produce a digital model of a desired final tooth arrangement. A series of intermediate digital models corresponding to successive tooth arrangements from the initial to final arrangements is generated from the digital models of the initial and final arrangements.

Removable aligning appliances (e.g., devices, shells, etc.) produced based on the intermediate digital models are then used to move the teeth toward the desired final positions. Repositioning is accomplished with a series of such appliances configured to receive the teeth in a cavity and incrementally reposition individual teeth in a series of successive steps. The successive use of a number of such appliances permits each appliance to be configured to move individual teeth in small increments.

The individual appliances typically include a polymeric shell having the tooth-receiving cavity formed therein. Each individual appliance is configured so that its tooth-receiving cavity has a geometry corresponding to an intermediate or end tooth arrangement intended for that appliance. That is, when an appliance is first worn by the subject, certain of the teeth will be misaligned relative to an undeformed geometry of the appliance cavity. The appliance, however, is sufficiently resilient to accommodate or conform to the misaligned teeth, and will apply sufficient resilient force against such misaligned teeth in order to reposition the teeth to the intermediate or end arrangement desired for that treatment step.

Existing systems for fabricating dental aligners from digital models of tooth arrangements may be slow and expensive as a result of requiring extensive manipulation of the digital models via conventional mouse and keyboard computer interfaces by users who view conventional flat representations of the digital models.

### SUMMARY

Methods and apparatus for visualizing and manipulating three-dimensional digital dental models and related methods and apparatus for dental treatments are disclosed. The three dimensional digital dental models may include, but are not limited to, digital models of individual teeth, groups of teeth, tooth arches, gingival tissue, and bone as well as digital models of dental appliances including, but not limited to, dental aligners. The dental treatment methods disclosed include, but are not limited to, fabrication of dental appliances such as, for example, dental aligners. The term “dental aligner” may refer to any dental device for rendering corrective tooth movement or for correcting malocclusion. One or more dental aligners can be worn on the subject's teeth so that a subject wearing the dental aligners will gradually have his or her teeth repositioned by the dental aligner “pushing” (or pulling) against the teeth and/or gums (gingiva). Additional uses for the disclosed methods and apparatuses other than manufacturing dental aligners are also contemplated.

In one aspect, a method is disclosed for visualizing and manipulating a three-dimensional digital dental model. The method may comprise viewing the three-dimensional dental model, and using hand gestures (e.g., hand signals, signs, positions, or movements) to instruct a computer to manipulate one or more teeth in the digital dental model. The digital dental model may comprise, for example, a digital model of a subject's tooth arch. Manipulating one or more teeth in the digital dental model may comprise, for example, rotating, translating, or rotating and translating one or more teeth in the digital dental model.

Using hand gestures to instruct the computer may comprise instructing the computer via at least one data glove or equivalent or similar device that measures orientations, positions, and/or movements of at least some of a user's fingers. A data glove is an input device in the form of a glove that measures orientations, positions, and/or movements of a wearer's fingers (and, optionally, wrist and elbow) and transmits that information to a computer. Alternatively, or in addition, using hand gestures to instruct the computer may comprise instructing the computer via at least one three-dimensional position sensing device that measures the three-dimensional position, or a change in the three-dimensional position, of at least one of the user's hands. Suitable hand gestures may include, but are not limited to, pointing, grabbing, and pinching hand and finger positions or motions, rotations and translations of the hand or fingers, and other hand and finger positions and motions that one of ordinary skill in the art having the benefit of this disclosure would find suitable. In some variations, a user selects a tooth movement with a gesture made with one hand and controls an extent of the movement with a gesture made with the other hand. The term “hand gesture” as used herein is not meant to include conventional keyboard typing or keyboard data entry.

In some variations an image of a hand (a “virtual hand”) is displayed with the digital model and controlled by a user's hand gestures to manipulate one or more teeth in the digital model. The virtual hand may mimic the user's hand positions and motions, for example, to allow the user to grasp and move an individual tooth with the virtual hand.

Manipulating the one or more teeth in the digital dental model may also comprise receiving force feedback relating to the forces necessary to manipulate one or more corresponding teeth in a subject's mouth in the same manner. The relationship between the forces may be, for example, linear, logarithmic, or non-linear in some other manner.

Viewing the three-dimensional digital model may comprise viewing a conventional flat representation of the three-dimensional model. Alternatively, viewing the three-dimensional digital model may comprise stereoscopically viewing the three-dimensional digital model. Stereoscopically viewing comprises viewing different images with each eye to create, for example, an illusion or perception of depth. Stereoscopically viewing the digital dental model may comprise viewing left-eye and right-eye images of the digital dental model presented on the same screen through a stereoscopic viewing device that transmits left-eye images to a user's left eye, transmits right-eye images to the user's right eye, blocks left-eye images from the user's right eye, and blocks right-eye images form the user's left eye. Alternatively, stereoscopically viewing the digital dental model may comprise viewing different images presented directly to a user's left and right eyes.

Any of the disclosed methods for viewing or stereoscopically viewing a three-dimensional digital model may be used in combination with any of the disclosed methods for using hand gestures to instruct a computer to manipulate one or more teeth in the digital model. Any such combinations may also include a user receiving force feedback representing the forces necessary to manipulate one or more corresponding teeth in a subject's mouth in the same manner.

In another aspect, a dental treatment method is disclosed. The method may comprise acquiring a three-dimensional digital model of a current arrangement of a subject's teeth, viewing the three-dimensional digital model of the current arrangement, using hand gestures to instruct a computer to manipulate one or more teeth in the digital model of the current arrangement to generate a three-dimensional digital model of a modified arrangement of the subject's teeth, and fabricating one or more dental aligners configured to reposition the subject's teeth into the modified arrangement.

The current arrangement of the subject's teeth may be, for example, a pretreatment arrangement. Alternatively, the current arrangement may have resulted from a previous treatment or from a previous stage of a treatment that the subject is undergoing. The modified arrangement may be, for example, a desired or predicted posttreatment arrangement of teeth in the subject's mouth expected or intended to result from a treatment plan, or an arrangement of teeth in the subject's mouth expected or intended to be intermediate between the current arrangement and a desired or predicted post-treatment arrangement. Intermediate and predicted or desired post-treatment arrangements of a subject's teeth may be referred to herein as “target” tooth arrangements or tooth arches.

In some variations, acquiring the digital model of the current arrangement comprises digitizing the subject's tooth arch in the subject's mouth, digitizing a negative impression of the tooth arch, and/or digitizing a positive model of the subject's current tooth arch. Such digitizing may be accomplished, for example, by acquiring images of or scanning the tooth arch, negative impression, and/or positive model. As used herein, scanning may include, but is not limited to, laser scanning, optical scanning, destructive scanning, computed tomography scanning, magnetic resonance imaging scanning, acoustic scanning, and scanning with a mechanical digitizing or scanning device.

The digital model of the current arrangement may also be acquired, for example, by acquiring a negative impression of the subject's tooth arch, casting a positive model of the tooth arch from the negative impression, separating the positive model into a plurality of physical tooth models, generating a plurality of digital tooth models from the plurality of physical tooth models, and generating the digital model of the current arrangement from the digital tooth models. The digital tooth models may be generated, for example, by acquiring images of or scanning the physical tooth models. The relative positions of the teeth in the current arrangement may be determined, for example, by acquiring images of or scanning the subject's tooth arch, a negative impression of the tooth arch, and/or a positive model cast from the negative impression.

Viewing the three-dimensional digital model of the current arrangement may comprise viewing a conventional flat representation of the digital model or stereoscopically viewing the digital model by, for example, any of the methods disclosed above.

Using hand gestures to instruct the computer to manipulate one or more teeth in the digital model of the current arrangement may comprise, for example, instructing the computer via a data glove or similar or equivalent device that measures orientations, positions, and/or movements of at least some of a user's fingers and/or instructing the computer via a three-dimensional position sensing device that measures the three-dimensional position, or a change in the three-dimensional position, of at least one of the user's hands. Manipulating one or more teeth in the digital model of the current arrangement may also comprise receiving force feedback relating to the forces necessary to manipulate one or more corresponding teeth in a subject's mouth in the same manner.

Any of the disclosed methods for viewing or stereoscopically viewing the three-dimensional model of the current arrangement may be used in combination with any of the disclosed methods for using hand gestures to instruct a computer to manipulate one or more teeth in the digital model of the current arrangement. Any such combinations may also include a user receiving force feedback relating to the forces necessary to manipulate one or more corresponding teeth in a subject's mouth in the same manner.

Fabricating one or more dental aligners may comprise, for example, arranging a plurality of physical tooth models to form a physical model of the modified arrangement and then forming (e.g., pressure or vacuum forming) the dental aligner over the physical model. In other variations, fabricating a dental aligner may comprise manufacturing a physical model of the modified arrangement by computer numerical control manufacturing based on the digital model of the modified arrangement, and then forming the dental aligner over the physical model. In yet other variations, fabricating a dental aligner may comprise generating a digital model of the dental aligner from the digital model of the modified arrangement, and manufacturing the dental aligner by computer numerical control manufacturing based on the digital model of the dental aligner.

In some variations, one or more digital models of arrangements of a subject's teeth intermediate between the current arrangement and the modified arrangement in a treatment plan are generated from the digital model of the current arrangement and the digital model of the modified arrangement. The one or more dental aligners may then be fabricated from the digital models of intermediate arrangements by methods similar or identical to those described above.

In yet another aspect, another dental treatment method is disclosed. The method may comprise stereoscopically viewing a three-dimensional digital model of an arrangement of a subject's teeth, manipulating one or more teeth in the digital model to generate a three-dimensional digital model of a modified arrangement of a subject's teeth, and fabricating one or more dental aligners to reposition the subject's teeth into the modified arrangement. The digital models may be stereoscopically viewed by any of the methods disclosed herein. Manipulating teeth in the digital models may comprise, for example, using a conventional keyboard and/or conventional mouse to instruct the computer to manipulate the teeth. Alternatively, or in addition, manipulating teeth in the digital models may comprise using hand gestures as disclosed herein, for example, to instruct the computer to manipulate the teeth. The one or more dental aligners may be fabricated by any of the methods disclosed herein.

Using hand gestures to instruct a computer to manipulate a digital dental model may, in some variations, be easier, faster, and less expensive than using a conventional mouse and/or keyboard to interact with the computer. Stereoscopically viewing a three-dimensional digital model, rather than viewing a flat representation of the digital model, may also allow easier, faster, and less expensive manipulation of the digital model in some variations because, for example, the stereoscopic view may allow a user to more accurately perceive the relative positions of various portions of the digital model.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

FIG. 1 shows a flow chart for an exemplary process for visualizing and manipulating a digital dental model.

FIG. 2 shows a flow chart for using hand gestures to instruct a computer to manipulate one or more teeth in a digital dental model according to some variations of the exemplary process of FIG. 1.

FIG. 3 shows an example of a user interface for displaying a digital representation of a subject's tooth arches. In this example, two windows are provided to display both a pre-modified tooth arch (shown in the left window) and a modified tooth arch (shown in the right window) in a side-by-side manner.

FIG. 4 shows a flow chart for an exemplary process for fabricating dental aligners as described herein.

FIG. 5 shows a perspective view of a casting chamber that may be used to cast a dental arch in some variations.

FIG. 6 shows a base plate for a dental arch attached to a casting chamber lid according to some variations.

FIG. 7 shows the use of a position measurement device to measure the locations and/or orientations of features in a negative impression of a dental arch according to some variations.

FIG. 8 shows a base plate attached to the lid of a casting chamber and placed over the casting chamber so that pins attached to the base plate are positioned within a negative impression of a tooth arch according to some variations.

FIG. 9 shows a positive mold of a subject's tooth arch according to some variations.

FIG. 10 shows physical tooth models separated from the positive mold of FIG. 6 according to some variations.

FIG. 11A shows a scanning system used to digitize physical tooth models according to some variations.

FIG. 11B shows a top view of physical tooth models mounted to a scan plate in the scanning system of FIG. 11A according to some variations.

FIG. 11C shows a side view of physical tooth models mounted to a scan plate in the scanning system of FIG. 11A according to some variations.

FIG. 12 shows examples of graphic projections of digital representations of physical tooth models according to some variations.

FIG. 13 shows a digital representation of a tooth arch generated from the digital representations of individual physical tooth models shown in FIG. 12 according to some variations.

FIG. 14 shows a base plate including sockets to which physical tooth models may be attached to form a dental arch according to some variations.

FIG. 15 shows a base plate to which physical tooth models have been attached to form a physical model of a tooth arch according to some variations.

FIG. 16 shows a polymeric sheet being placed over a physical model of a tooth arch for formation of a removable aligner according to some variations.

FIG. 17 shows a removable aligner formed from the set-up of FIG. 16 according to some variations.

FIG. 18 shows a removable aligner after excess material has been trimmed away according to some variations.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

Before describing the present invention, it is to be understood that unless otherwise indicated this invention need not be limited to applications in orthodontic treatments. As one of ordinary skill in the art having the benefit of this disclosure would appreciate, variations of the invention may be utilized in various other dental applications, such as fabrication and/or treatment planning for dental crowns and dental bridges as well as to support research and/or teaching applications. Moreover, it should be understood that variations of the present invention may be applied in combination with various dental diagnostic and treatment devices to improve the condition of a subject's teeth.

It must also be noted that, as used in this specification and the appended claims, the singular forms “a,” “an” and “the” include plural referents unless the context clearly indicates otherwise. Thus, for example, the term “a tooth” is intended to mean a single tooth or a combination of teeth. Furthermore, as used herein, “generating”, “creating”, and “formulating” a digital model or digital representation mean the process of utilizing computer calculation to create a numeric representation of one or more objects. For example, the digital model or digital representation may comprise a file saved on a computer, wherein the file includes numbers that represent a three-dimensional projection of a tooth arch. In another variation, the digital model or digital representation comprises a data set including parameters that can be utilized by a computer program to recreate a digital model of the desired objects.

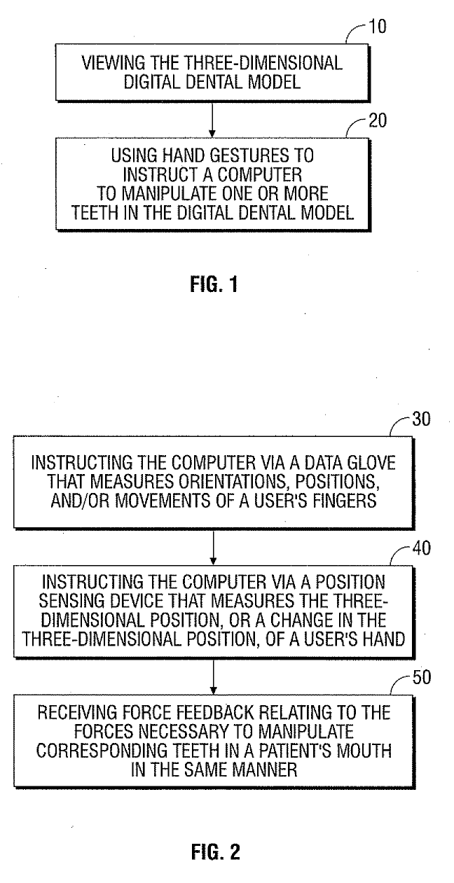

Examples and variations of methods and apparatus that may be used for visualizing and manipulating three-dimensional digital dental models are disclosed herein. To illustrate these methods and apparatus, several variations of an exemplary process for visualizing and manipulating three-dimensional digital dental models, shown in the flow chart of FIG. 1, are described in detail. Variations of this process may include additional steps not shown in FIG. 1. The steps need not be executed in the order depicted, and may be executed concurrently in some variations. One of ordinary skill in the art having the benefit of this disclosure will appreciate that variations of this process and of the disclosed methods and apparatus may be utilized in various dental applications including, but not limited to, the fabrication of dental appliances such as, for example, dental aligners.

Referring now to FIG. 1, in step 10 of the exemplary process for visualizing and manipulating a three-dimensional digital dental model the digital dental model is viewed. In some variations, a conventional flat representation of the three-dimensional digital model is viewed on a conventional display apparatus such as, for example, a CRT display, a liquid crystal display, or a plasma display. In other variations, the three-dimensional digital dental model is viewed stereoscopically.

Stereoscopically viewing the digital dental model may comprise, for example, viewing left-eye and right-eye images of the digital dental model presented on the same screen through a stereoscopic viewing device that transmits left-eye images to a user's left eye, transmits right-eye images to the user's right eye, blocks left-eye images from the user's right eye, and blocks right-eye images form the user's left eye. The left-eye and right-eye images may be displayed on a conventional CRT, for example, by software running on a conventional computer such as a personal computer or work station. The computer may comprise, for example, a conventional graphics card such as, for example, an NVIDIA Quadro4 graphics card available from NVIDIA Corporation capable of driving a display device for stereoscopic viewing.

Suitable stereoscopic viewing apparatus may include, but are not limited to, stereoscopic goggles such as CrystalEyes 3 stereoscopic goggles available from Stereographics Corporation. Such goggles may operate by synchronizing shutters (such as liquid crystal display shutters, for example) located in front of a user's right and left eye with the display of right-eye images and left-eye images on a display device such as a CRT. Other types of stereoscopic viewing apparatus known to one of ordinary skill in the art may also be suitable, however. For example, left-eye and right-eye images may be displayed in different colors or with different light polarizations (e.g., different linear or circular polarization) and optical elements such as polarizers or color filters located in front of the user's left and right eye may selectively pass the left-eye and right-eye images to the appropriate eyes.

Alternatively, stereoscopically viewing the digital dental model may comprise, for example, viewing left-eye and right-eye images of the digital dental model presented directly to the user's left and right eyes and/or displayed on separate display screens for each eye. In such variations, a stereoscopic viewing apparatus in the form of goggles, for example, may include separate display screens for each eye.

Referring again to FIG. 1, in step 20 of the exemplary process for visualizing and manipulating a three-dimensional digital model a user uses hand gestures to instruct the computer to manipulate one or more teeth in the digital dental model. Manipulating one or more teeth in the digital dental model may comprise, for example, rotating, translating, or rotating and translating one or more teeth in the digital dental model. In some variations, teeth in the digital dental model may also be removed, added, or altered in size and/or shape, for example.

In some variations step 20 may be accomplished by the methods illustrated in the flow chart of FIG. 2. Variations of the exemplary process need not include all of the steps shown in FIG. 2 and may include additional steps not shown. The steps shown in FIG. 2 need not be executed in the order depicted, and may be executed concurrently in some variations.

In some variations (FIG. 2, step 30), using hand gestures comprises instructing the computer via at least one data glove or equivalent or similar input device that measures orientations, positions, and/or movements of at least some of a user's fingers. Suitable computer input devices may include, but are not limited to, data gloves available from Fifth Dimension Technologies, Inc. and data gloves available from Immersion Corporation. Finger orientations, positions, and/or movements may be used, for example, to select a tooth or teeth to be manipulated, to select a type of manipulation (e.g., rotation, translation), to select the direction of a tooth motion, and to control the extent of the motion. One of ordinary skill in the art having the benefit of this disclosure will appreciate that suitable sign languages may be devised allowing a user to manipulate the digital dental model with finger orientations, positions, and/or movements detected by the data glove, and would be able to devise such sign languages.

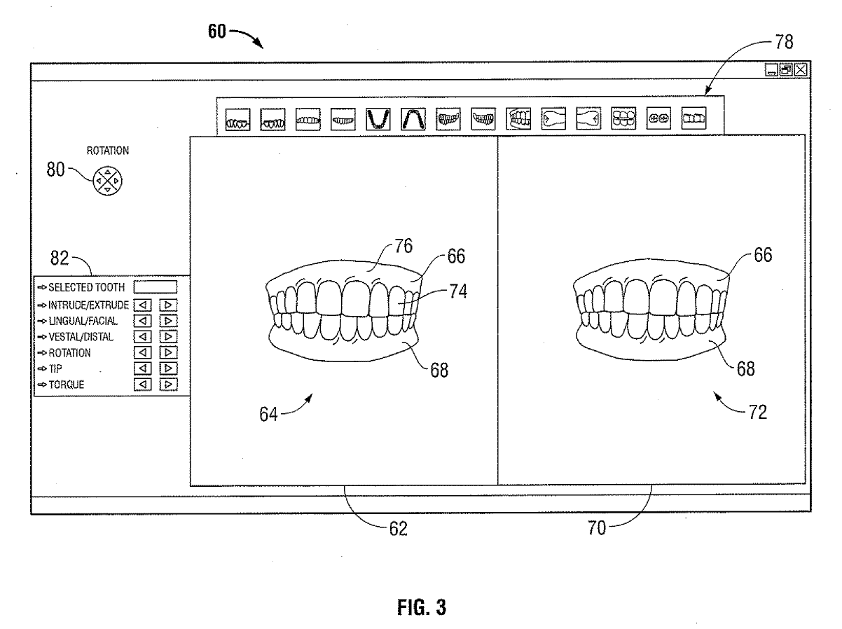

In some variations, a user wearing a data glove on each hand selects a tooth movement with a gesture made with one hand and controls the extent of the tooth movement with a gesture made with the other hand. In one variation, a user wearing two data gloves views the digital dental model on a screen including a menu (such as or similar to the user interface shown in FIG. 3 and described below). A first data glove controls the menu, which may include, for example, motions and/or motion directions such as: rotate left, rotate right, intrude, extrude, lingual, facial, mesial, distal, tip, and torque. A second data glove controls a motion selected from the menu using the first data glove. In one example of a sign language that may be used in such variations, the user selects the tooth to be manipulated by making one or more fist motions with the hand wearing the first data glove. Each fist motion highlights the next tooth in a sequence, allowing any tooth to be selected. The user then makes one or more pinching motions with the index finger and thumb of the hand wearing the first data glove to scroll through and select an action or direction from the menu list. The user controls (e.g., activates and deactivates) the intended motion by making one or more pinching motion using the hand wearing the second data glove.

In other variations (FIG. 2 step 40), using hand gestures comprises instructing the computer via at least one position sensing device that measures the three-dimensional position, or change in three-dimensional position, of at least one of a user's hands. Suitable position sensing devices may include, but are not limited to, conventional optical and magnetic motion tracking systems available from Fifth Dimension Technologies, Inc. Use of such position sensing technologies may involve attaching signal sensors or emitters to the user's hands, for example. Suitable position sensing devices may also include, for example, three-dimensional digitizers such as the MicroScribe® digitizers available from Immersion Corporation. Such a three-dimensional digitizer can be held in or attached to a user's hand to detect the hand gestures. Hand positions, orientations, and/or movements may be used, for example, to select a tooth or teeth to be manipulated, to select a type of manipulation (e.g., rotation, translation), to select the direction of a tooth motion, and to control the extent of the motion. One of ordinary skill in the art having the benefit of this disclosure will appreciate that suitable sign languages similar to that described above, for example, may also be devised allowing a user to manipulate the digital dental model with hand motions detected by one or more position sensing devices, and would be able to devise such sign languages. Such sign languages may also involve detecting hand gestures made using either or both hands.

In yet other variations (FIG. 2, steps 30 and 40), using hand gestures comprises instructing the computer via at least one data glove or similar or equivalent input device that measures orientations, positions, and/or movements of a user's fingers and at least one position sensing device that measures the three-dimensional position, or change in three-dimensional position, of at least one of the user's hands. This may be accomplished, for example, with any suitable combination of data gloves and three-dimensional position sensing devices. In one example, three-dimensional tracking devices available from Polhemus, Ascension Technology Corporation, or InterSense Inc. are attached to a CyberGlove® data glove available from Immersion Corporation to provide three-dimensional position information, yaw, pitch, and roll angle information, and joint angle measurements. Hand and finger positions, orientations, and/or movements may be used, for example, to select a tooth or teeth to be manipulated, to select a type of manipulation (e.g., rotation, translation), to select the direction of a tooth motion, and to control the extent of the motion. One of ordinary skill in the art having the benefit of this disclosure will appreciate that suitable sign languages similar to that described above, for example, may also be devised allowing a user to manipulate the digital dental model with hand gestures detected by one or more data gloves and one or more three-dimensional position sensing devices, and would be able to devise such sign languages. Such sign languages may also involve detecting hand gestures made using either or both hands.

Any of the methods for using hand gestures to instruct a computer to manipulate one or more teeth in the three-dimensional digital dental model may be used in combination either with conventional viewing of a flat representation of the three-dimensional digital model or with stereoscopic viewing.

In one example, a user wears a CyberGlove® data glove from Immersion Corporation in combination with a Polhemus Patriot™ six-degree-of-freedom tracking sensor attached to the user's index finger tip, and views the three-dimensional dental model stereoscopically. The user selects a tooth to be manipulated by moving the hand to alternately highlight the teeth in the digital model, and then making a fist to select a currently highlighted tooth. The user may hold the hand in an upright, palm out, “swearing in” position, for example, and wave it back and forth to highlight different teeth. After selecting a tooth to be manipulated, the user may use a similar combination of hand motions and hand positions to select a tooth movement from a menu in a user interface, for example, and then to control the extent of the tooth movement.

In another example, the user again wears a CyberGlove® data glove from Immersion Corporation in combination with a Polhemus Patriot™ six-degree-of-freedom tracking sensor attached to the user's index finger tip, and views the three-dimensional dental model stereoscopically. The user uses the position in real space of the tracking sensor to control the position of a virtual pointer or marker (e.g., a sphere or other shape, a cross-hair, or a virtual hand) in the virtual space of the digital dental model. The user may use the virtual pointer or marker to select a tooth to be manipulated by, for example, touching, poking, or pointing to it in the virtual space of the digital model. After selecting the tooth or teeth, the user may then use the virtual pointer or marker, for example, to select a tooth movement from a menu in a user interface and to control the extent of the movement. Hand gestures controlling the position of the virtual pointer or marker may also be used in combination with other hand gestures (e.g., fist motions, hand rotations, hand translations, pinching motions) to select teeth and tooth motions and to control those motions.

In some variations, a user's hand gestures are mimicked by an image of a hand (i.e., a “virtual hand”) displayed with the digital dental model. The hand gestures may be detected as described above, for example. In some of these variations the user can grasp individual teeth in the digital dental model with the virtual hand and move the teeth to desired positions. This may require calibrating the relationship between the positions and motions of the user's hand in real space and the positions and motions of the virtual hand in the virtual space of the digital dental model. Such calibration may be done, for example by conventional methods known to one of ordinary skill in the art. In some variations, a user receives a signal such as a visual signal, for example, that a particular tooth has been grasped. For example, a tooth in the digital dental model may change color or light up when grasped by the virtual hand.

Sensors used to detect hand gestures in the methods disclosed herein may, in some variations, provide large quantities of data at a rate greater than can be processed by a processor controlling the display of the digital dental model and any other virtual objects in the virtual space such as, for example, virtual pointers, markers, or hands. In some variations, for example, the sensors provide data at an update rate of 60 Hz. Several approaches may be used alone or in combination to provide smooth and continuous movements of the teeth and other virtual objects despite high data collection rates that threaten to overwhelm or choke the processor.

In one approach, the collected data is not buffered. Instead, data that cannot be processed rapidly enough is lost or discarded. Despite the lost data, however, the data stream is sampled sufficiently frequently that a viewer will perceive the virtual objects to be moving smoothly in the display. In another approach, the sensor space (i.e., real space) is quantized or divided into small volumes. If the sensor is in the same volume it was in at the last update, then the display is not altered. The volume size may be selected to reduce the rate at which the display is updated but preserve the perception by viewers of smooth motions in the display. In another approach, sensor data is processed to update the display only if the sensor has moved from its previous position by a distance greater than a threshold value. The threshold distance may also be selected to reduce the rate at which the display is updated but preserve the perception by viewers of smooth motions in the display. In yet another approach, the trajectory of an object moving in virtual space is adjusted and/or smoothed by conventional smoothing algorithms.

Manipulating one or more teeth in the digital dental model may comprise a user receiving force feedback relating to the forces necessary to manipulate one or more corresponding teeth in a subject's mouth in the same manner (FIG. 2, step 50). In some variations, a user's hand gestures are mimicked as described above by a virtual hand which can be used to manipulate teeth in the digital dental model, and the user receives force feedback delivered to the mimicked hand relating to forces exerted by (or exerted on) the virtual hand as it manipulates the digital teeth. The forces may be calculated, for example, from physical models that take into account the physical properties (e.g., elasticity) of gum tissue, bone, and teeth and recognize or predict when attempted tooth movements result in collisions between teeth. The force feedback may also allow the user to feel the texture of the object grasped. Suitable force feedback devices may include, but are not limited to, the CyberGrasp™ system available from Immersion Corporation.

In other variations, a user manipulates one or more teeth in the digital model using hand gestures and a sign language system as described above, for example, and receives force feedback relating to the forces necessary to manipulate one or more corresponding teeth in a subject's mouth in the same manner. The force feedback may be delivered, for example, as resistance to finger or hand motions used to control the extent of a particular tooth motion.

FIG. 3 shows a user interface 60 that may be used to display one or more three-dimensional digital dental models to be viewed and manipulated. In the illustrated example, user interface 60 includes a left window 62 displaying a three-dimensional digital model 64 of a subject's upper 66 and lower 68 tooth arches, and a right window 70 displaying another three-dimensional model 72 of the subject's upper 66 and lower 68 tooth arches. The tooth arches may include, for example, teeth 74 and gingival tissue 76. The digital model displayed in right window 70 may be, for example, a modification of the digital model displayed in left window 62. The side by side display of the digital dental models in the illustrated examples allows a user to easily view and compare the digital dental models while manipulating one or both of them. In other variations, user interface 60 may include more or fewer windows displaying more or fewer digital dental models.

User interface 60 may be controlled using hand gestures as described above, for example, and in some variations may display, for example, a virtual pointer, marker, or hand (not shown) that can be used to manipulate the displayed digital dental models. In the illustrated example, hand gestures may be used, for example, to select views of digital dental models 64 and 72 from a set of preset views 78 and/or to rotate either or both digital dental models in space using rotation control 80. Individual teeth in the displayed digital dental models may be selected and manipulated by using hand gestures to select and activate options listed in menu 82.

User interface 60 may include display logic for controlling the display of digital dental models. The display logic may be in the form of computer- or machine-readable code which may run on a computer. The features of user interface 60 may be arranged in any appropriate manner. Although in the illustrated example user interface 60 is shown having a particular combination of features, in other variations user interface 60 may include other combinations of features. User interface 60 may include, for example, features included in user interfaces disclosed in U.S. patent application Ser. No. 11/404,643, entitled “COMPUTER AIDED ORTHODONTIC TREATMENT PLANNING,” filed Apr. 13, 2006, which is incorporated herein by reference in its entirety.

As illustrated in examples above, in some variations sensors detecting hand gestures may be used as a three-dimensional mouse to navigate in a virtual three-dimensional world viewed stereoscopically. This may provide a user manipulating a digital dental model in the virtual world with an advantageous perception of depth absent from a flat representation. Selected or viewed teeth in the digital model may appear to “pop out” in front of the user's eyes, for example. In some variations, the depth perceived by the user can be adjusted by the user with, for example, hand gestures or mouse clicks.

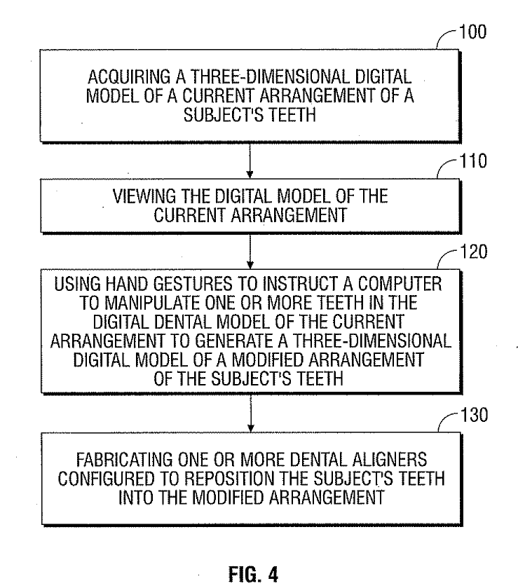

Examples and variations of dental treatment methods and apparatus are also disclosed herein. To illustrate these methods and apparatus, several variations of an exemplary process for fabricating one or more dental aligners, shown in the flow chart of FIG. 4, are described in detail. Variations of this process need not include all of the steps or apparatus shown in FIG. 4, and may include additional steps and apparatus not shown. The steps need not be executed in the order depicted and, in some variations, two or more of the steps may be executed concurrently. One of ordinary skill in the art having the benefit of this disclosure will appreciate that variations of this process and of the disclosed methods and apparatus may be utilized in other dental applications as well.

Referring now to FIG. 4, instep 100 of the exemplary process for fabricating one or more dental aligners a three-dimensional digital model of a current arrangement of a subject's teeth is acquired. This may be accomplished, for example, by casting a positive mold of the subject's (e.g., upper or lower) tooth arch from a negative impression of the tooth arch, separating the positive mold into individual physical tooth models or physical models of groups of teeth, scanning or otherwise digitizing the physical tooth models, and then generating the digital model of the current arrangement of the subject's teeth from the digital tooth models. Variations of this approach are disclosed in International Patent Application No. PCT/US2005/039715 titled “METHODS AND APPARATUSES FOR MANUFACTURING DENTAL ALIGNERS,” filed Nov. 2, 2005, which is incorporated herein by reference in its entirety.

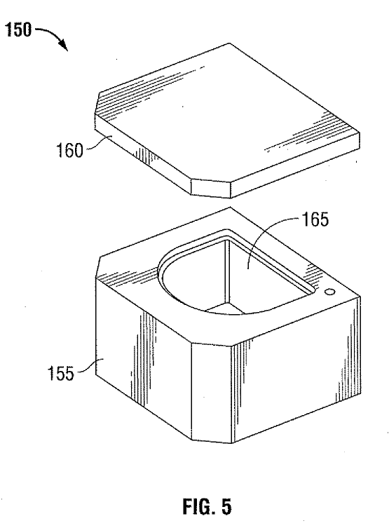

Some variations of the approach just described for acquiring a digital model of the current arrangement of the subject's teeth are described next with respect to FIGS. 5-13. First, a negative impression of the subject's tooth arch is obtained by, for example, conventional methods known to one of ordinary skill in the art. The dental impression may be prepared using a dental tray filled with polyvinlysiloxane, for example. Next, a positive mold of the tooth arch is cast from the negative impression by casting techniques including, but not limited to, those disclosed herein, those known to one of ordinary skill in the art, and improvements and combinations thereof.

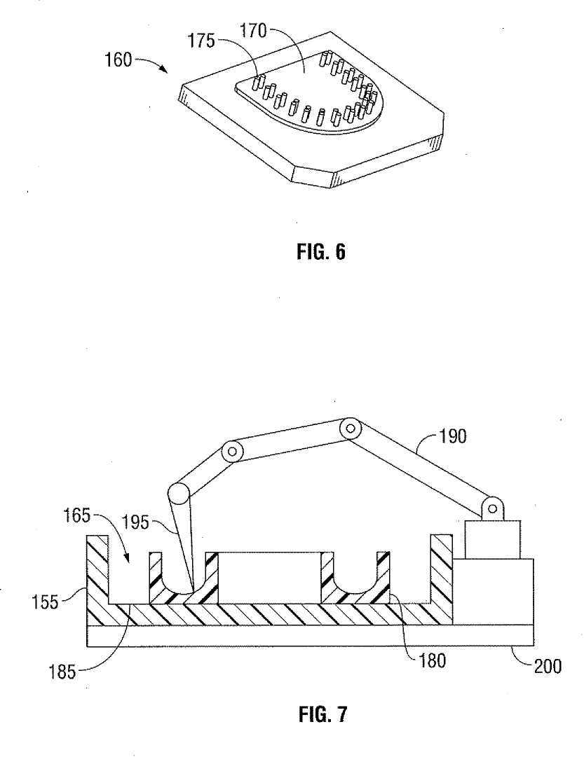

FIG. 5 shows an example casting chamber 150 that may be used in some variations to cast a positive mold of the tooth arch from the negative impression. Casting chamber 150 comprises a chamber body 155 and a lid 160. Chamber body 155 includes a cavity 165 in which the negative impression of the dental arch may be placed. Casting chamber body 155 and lid 160 may also include pins and alignment holes, not shown, allowing lid 160 to be precisely and reproducibly placed on chamber body 155. FIG. 6 shows the underside of lid 160 to which has been attached a base plate 170 onto which a positive model of the tooth arch may be cast. The fabrication of base plate 170 is described below. Lid 160 and base plate 170 also optionally include alignment pins and alignment holes, not shown, allowing base plate 170 to be precisely and reproducibly placed with respect to lid 160 and thus chamber body 155.

Referring now to FIG. 7, the negative impression 180 of the subject's tooth arch is placed in casting chamber body 155 and coupled (e.g., glued, bonded, interlocked, etc.) to the bottom 185 of casting chamber cavity 165. A three-dimensional position input device (e.g., a three-dimensional digitizer) 190 is then utilized to determine the locations and orientations of the teeth in the negative impression of the tooth arch. In some variations position input device 190 is a mechanical location determination device such as, for example, a MicroScribe®, available from Immersion Corporation. In the example shown in FIG. 7, position input device 190 is such a mechanical location determination device including a stylus 195 that may be positioned at points within negative impression 180. Position input device 190 may then measure, for example, the spatial orientation of stylus 195 and/or the position of its tip.

In other variations, the locations and orientations of the teeth in the negative impression of the tooth arch may be determined, for example, by acquiring images of the negative impression and/or scanning the negative impression. Such use of images is disclosed, for example, in International Patent Application No. PCT/US2005/045351 titled “IMAGE BASED ORTHODONTIC TREATMENT METHODS,” filed Dec. 14, 2005, which is incorporated herein by reference in its entirety. Various suitable scanning techniques are disclosed, for example, in International Patent Application No. PCT/US2005/039715 titled “METHODS AND APPARATUSES FOR MANUFACTURING DENTAL ALIGNERS,” filed Nov. 2, 2005, which is incorporated herein by reference in its entirety.

Referring again to FIG. 7, to facilitate the measurement of the locations and orientation of the teeth in negative impression 180, position input device 190 and casting chamber body 155 may be fixed to a common platform 200. A coordinate system based on casting chamber body 155 can then be established by manipulating stylus 195 to measure the locations of two points on the casting chamber body 155 to define the x axis. The y axis may be established with a third reading. For example, the x-y plane may be defined on the surface that receives the negative impression. The z axis can be determined by taking the cross product of the x and y axes. The locations and orientations of the teeth in negative impression 180 may then be measured with respect to the coordinate system on chamber body 155 by placing stylus 195 at points on or in the tooth impressions. A computer may then be used to record the position of stylus 195. In one variation, the placement of stylus 195 is controlled by an operator. In another variation, an automated system having optical and/or tactile feedback is utilized to position stylus 195.

After the locations and orientations of the teeth in negative impression 180 have been acquired, base plate 170 (FIG. 6) is fabricated to include one or more sockets or other receptacles (e.g., drill holes) located and oriented to correspond to the location and orientation of each tooth in the tooth arch. Pins 175 are then inserted into the sockets. The socket locations and orientations may be chosen such that pins 175 approximately correspond to the positions of the roots of the teeth. The socket locations and orientations may also be chosen so that the sockets and pins of neighboring teeth do not interfere with each other. In variations in which the position of base plate 170 attached to lid 160 can be precisely determined when lid 160 is attached to chamber body 155, the coordinate system in which position input device 190 (FIG. 7) characterized negative impression 180 can be easily transposed to the base plate 170. This can facilitate accurate and precise fabrication of the sockets in base plate 170.

Base plate 170 may be made from materials including, but not limited to, plastics, metals, and machineable waxes. The sockets in base plate 170 may be formed by methods including, but not limited to, computer numerical control based machining (e.g., drilling), laser machining, and printing or forming sockets in a soft material which is later cured or hardened.

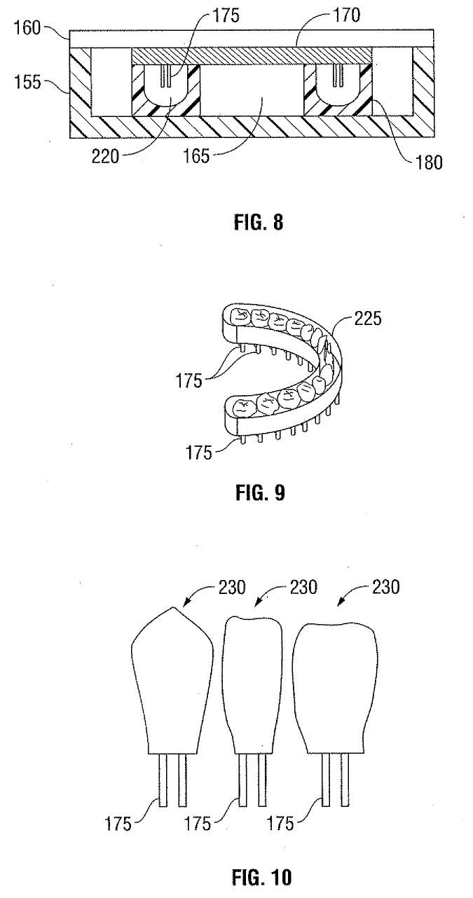

As shown in FIG. 8, after pins 175 are inserted into base plate 170, base plate 170 is attached to casting chamber lid 160, and lid 160 is flipped over and placed on top of chamber body 155 holding the negative impression 180 of the tooth arch. In the illustrated example, when the lid 160 and chamber body 155 are properly aligned, each pair of pins in base plate 170 corresponds to a tooth in the tooth arch represented by the negative impression.

Next, a casting material is injected into the cavity 220 of the negative impression 180, which is positioned within the casting chamber cavity 165. Suitable casting materials include, but are not limited to, epoxy materials, polymers, and plasters. Optionally, heat, infrared light, or ultraviolet light, for example, may be applied to promote curing of the casting material. The casting material cures to form a positive arch 225 (FIG. 9) within the negative impression, with pins 175 bonded to the positive arch. In some variations positive arch 225 is cast by sequentially applying and curing multiple layers of casting material to form a layered model of the dental arch. Examples of multi-layer casting methods and devices are disclosed in U.S. patent application Ser. No. 11/258,465, entitled “MULTI-LAYER CASTING METHODS AND DEVICES,” filed Oct. 24, 2005, which is incorporated herein by reference in its entirety.

After positive arch 225 has cured and/or hardened, it is decoupled from negative impression 180. The teeth in the positive tooth arch 225 are then separated to form physical models 230 of the individual teeth, as shown in FIG. 10. Separation may be achieved by, for example, sawing, laser cutting, or other techniques that are well known to one of ordinary skill in the art.

After the separation of positive tooth arch 225, individual physical tooth models 230 may be digitized as described next, for example, to form digital models of the individual teeth. Examples of digitization of physical tooth models and construction of a digital dental arch from digital models of teeth are disclosed, for example, in International Patent Application No. PCT/US2005/039715 titled “METHODS AND APPARATUSES FOR MANUFACTURING DENTAL ALIGNERS,” filed Nov. 2, 2005, which is incorporated herein by reference in its entirety.

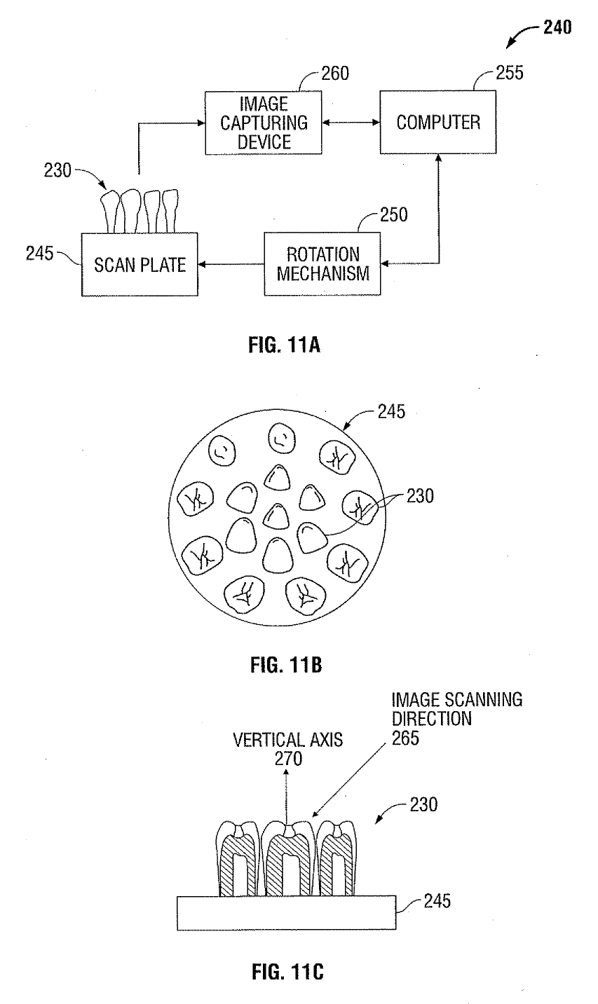

In one variation, physical tooth models 230 are digitized by scanning system 240 shown in FIG. 11A. Scanning system 240 includes a scan plate 245 on which one or more physical tooth models 230 can be mounted. Scan plate 245 can be rotated by a rotation mechanism 250 under the control of a computer 255. The rotation mechanism 250 can include a motor and a gear transport mechanism that is coupled to the scan plate 245. As scan table 245 rotates, an image capture device 260 captures images of physical tooth models 230. The coordinates of a plurality of surface points on the physical tooth models 230 can be computed, for example, by triangulation using the captured image data. The surfaces of the physical tooth models 230 can be constructed by interpolating computed coordinates of the points on the surface. Image capture device 260 can be, for example, a digital camera, digital video camera, laser scanner, or other optical scanner. Some variations utilize a plurality of image capture devices. The throughput and accuracy of the digitization process may increase with the number of image capture devices used.

In some variations, the individual physical tooth models 230 are placed on scan plate 245 one at a time and scanned one at a time. In other variations, a plurality of individual physical tooth models 230 are place onto scan plate 245 and scanned together. For example, in one variation eight physical tooth models 230 are scanned at a time. In another variation sixteen physical tooth models 230 are scanned at a time. In general, the scanning throughput is increased with increased packing density on scan plate 245. However, higher packing density may decrease the distance between the physical tooth models 230, which may cause the adjacent physical tooth models 230 to block each other in image captures. Various techniques that are well known to one of ordinary skill in the art may be utilized to determine the desired packing density and distribution pattern for placement of physical tooth models 230 on scan plate 245.

FIG. 11B is atop view, illustrating one variation of a tooth model platform for scanning. In this variation, two or more physical tooth models 230 are mounted to a scan plate 245. Physical tooth models 230 can have different sizes and shapes. In the example of FIG. 11B the small circles may be, for example, about 10 mm in diameter and represent small teeth (e.g., lower incisors, canine, etc.) or tooth components. The large circles may be, for example, about 15 mm in diameter and represent large teeth (e.g. upper central incisors, molars) or larger tooth components. In this example, physical tooth models 230 are placed, for example, at least about 5 mm apart from each other and at almost equal height to avoid overlap. Scan plate 245 may be about 150 mm in diameter, for example. The packing efficiency of physical tooth models 230 can be determined by their sizes, heights, and shapes and by their distribution on scan plate 245. As one of ordinary skill in the art having the benefit of this disclosure would appreciate, other distributions of physical tooth models 230 on a scan plate 245 differing from that shown in FIG. 11B may also be suitable.

FIG. 11C shows a side view of scan plate 245 in one variation. Physical tooth models 230 are mounted on scan plate 245 in a substantially vertical orientation. Images of the physical tooth models are scanned or captured from a direction 265 oblique to the physical tooth models 230 such that their top and side surfaces can be captured at different angles as scan plate 245 is rotated. For example, the image capture direction 265 can be about 45 degree off vertical axis 270. Other relative orientations of the image capture direction 265 and the physical tooth models may also be suitable. In some variations scan plate 245 can be mounted on goniometer and/or translation stages which can provide up to 6 axes for 6 degree of freedom movements.

In some variations, physical tooth models 230 are mounted on scan plate 245 by inserting pins 175 on physical tooth models 230 into sockets formed in scanning plate 245. The positions and orientations of the sockets are precisely known. Hence, the positions and orientations of pins 175 and physical tooth models 230 during the scanning process can be determined in relation to the sockets. Thus, once the surface of a physical tooth model 230 has been digitized, the coordinates of the surface of that tooth are known with respect to the positions of the pins in that tooth. That is, the location of points on the surface of a digitized tooth and the location of the pins in that tooth can be translated into the same coordinate system. Consequently, if the positions of the pins are known or defined, then the positions of points on the surface of the tooth are also known.

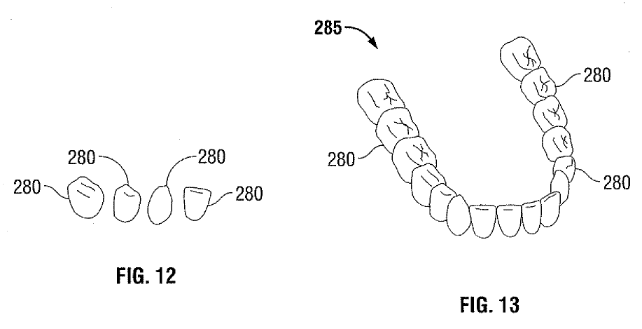

FIG. 12 illustrates examples of graphic projections of the individual digital representations 280 of selected teeth, each of which comprises a crown portion of the corresponding tooth. In one variation, a section of the gingival tissue (not shown) is also digitized.

Digital tooth models may also be generated from physical tooth models by, for example, other methods known to one of ordinary skill in the art and by image-based methods disclosed in International Patent Application No. PCT/US2005/045351 titled “IMAGE BASED ORTHODONTIC TREATMENT METHODS,” filed Dec. 14, 2005, which is incorporated herein by reference in its entirety.

Once the individual physical tooth models 230 have been digitized, the digital representations 280 of individual teeth may be utilized by a computer program to generate a digital representation 285 (FIG. 13) of the subject's current tooth arch. In some variations, the computer uses the relative locations and orientations of pins 175 in positive arch 225 (or, equivalently, in base plate 170) to calculate the relative positions of corresponding digital tooth models 280 required to align digital tooth arch model 285 with positive arch 225.

In other variations, the relative locations and orientations of the teeth in the current tooth arch may be determined, for example, by acquiring images of or scanning the subject's tooth arch, negative impression 180, or positive arch 225 and then used to arrange digital tooth models 280. The relative positions of the teeth may be determined from the image or scan data by, for example, conventional methods known to one of ordinary skill in the art and/or by methods disclosed in the international patent applications cited above.

In yet other variations, a preliminary digital model of the current tooth arch is generated by acquiring images of or scanning the subject's tooth arch, negative impression 180, or positive arch 225 by, for example, conventional methods known to one of ordinary skill in the art and/or by methods disclosed in the international patent applications cited above. Digital tooth models 280 are then superimposed on the preliminary digital model of the current arch, and their locations and orientations are adjusted to match those of the corresponding teeth in the initial digital model. The resulting digital model of the current tooth arch generated from digital tooth models may include information not present in the preliminary digital model.

Although the approach just described utilized digital tooth models 280 in the generation of digital model 285 of the subject's current tooth arch, this need not be necessary. For example, in some variations a suitable digital model of the subject's current tooth arch may be generated by acquiring images of or scanning the subject's tooth arch, negative impression 180, or positive arch 225 without incorporating additional information from scans or images of individual teeth or groups of teeth.

In some variations, the teeth in the digital model of the current tooth arch include roots. The roots may be added to digital tooth models 280 prior to arranging the digital teeth to model the current tooth arch. Alternatively, the roots may be added to the teeth in the digital model of the current tooth arrangement after the crown portion of the model has been generated. Information from x-rays of the subject's tooth arch may be used in generating such digital tooth roots.

Although the generation of a digital model of only a single (e.g., upper or lower) tooth arch was described above, one of ordinary skill in the art having the benefit of this disclosure would appreciate that digital models of both upper and lower tooth arches may be prepared by the methods and apparatus disclosed above.

Referring again to FIG. 4, in step 110 of the exemplary process for fabricating one or more dental aligners the three-dimensional digital model of the current arrangement is viewed. The digital model of the current arrangement may be viewed stereoscopically, for example, by any of the methods disclosed above with respect to the exemplary process for visualizing and manipulating a three-dimensional digital dental model. Alternatively, a conventional flat representation of the three-dimensional model may be viewed on a conventional display apparatus. In some variations, the digital model of the current arrangement is viewed and manipulated (step 120) with a user interface such as the user interface described above with respect to FIG. 3.

In step 120 of the exemplary process for fabricating one or more dental aligners, a user uses hand gestures to instruct a computer to manipulate one or more teeth in the digital dental model of the current arrangement to generate a three-dimensional digital model of a modified arrangement of the subject's teeth. The user may be, for example, an operator, technician, or other user involved with fabricating dental aligners, or the subject's dentist, orthodontist, or other dental professional. The modified arrangement may be, for example, a desired or predicted post-treatment arrangement of teeth in the subject's mouth expected or intended to result from a treatment plan, or an arrangement of teeth in the subject's mouth expected or intended to be intermediate between the current arrangement and a desired or predicted post-treatment arrangement. The user may use, for example, any of the methods described above for using hand gestures to instruct a computer to manipulate or modify a digital dental model.

In some variations, the subject's dentist, orthodontist, or other dental professional provides an operator with a prescription for a desired post-treatment arrangement of the subject's teeth, and the operator generates a three-dimensional model of a modified arrangement representing the prescribed arrangement using hand gestures to instruct a computer as described above, for example, or using conventional keyboard and/or mouse computer interfaces. The subject's dental professional is then provided with an opportunity to view, approve, disapprove, and/or manipulate the digital model of the modified arrangement prior to fabrication of one or more dental aligners. The dental professional may view the digital model stereoscopically or view a conventional flat representation, and may manipulate the digital model using hand gestures as described above. For example, the dental professional may view and manipulate the digital dental model with a user interface such as the user interface described above with respect to FIG. 3, for example.

In some variations in which the modified arrangement represents a desired post-treatment arrangement of the subject's teeth, the modified arrangement is used as a visual reference by a user who generates one or more digital models of intermediate arrangements of the subject's teeth intermediate between the current arrangement and the desired post-treatment arrangement. The user may generate these digital models of the intermediate arrangements using the methods for viewing and manipulating three-dimensional digital dental models described above. Hence, digital models of intermediate arrangements generated in this manner may also be examples of digital models of modified arrangements as referred to in step 120 of FIG. 4.

In other variations in which the modified arrangement represents a desired post-treatment arrangement of the subject's teeth, digital models of intermediate arrangements are generated automatically by interpolation, for example, or using conventional keyboard and/or mouse computer interfaces. Also, in some variations a user may specify particular intermediate positions for particular teeth (using the viewing and manipulating methods described above, for example) but allow other intermediate positions for the teeth to be determined automatically. Software generating or enabling an operator to generate intermediate digital tooth arch models may impose anatomically-derived limitations on the extent of movement and/or force applied to each tooth.

Referring again to FIG. 4, in step 130 one or more dental aligners are fabricated. In some variations, a physical model of an arrangement of the subject's teeth is fabricated based on a digital model of the arrangement and then used to fabricate a dental aligner by, for example, forming (e.g., pressure or vacuum forming) a sheet of aligner material over the physical model. The physical model may be constructed, for example, based on a digital model of a modified arrangement of the subject's teeth generated in step 120, or based on a digital model of an intermediate arrangement of the subject's teeth generated from or by visual reference to a digital model of a modified arrangement generated in step 120.

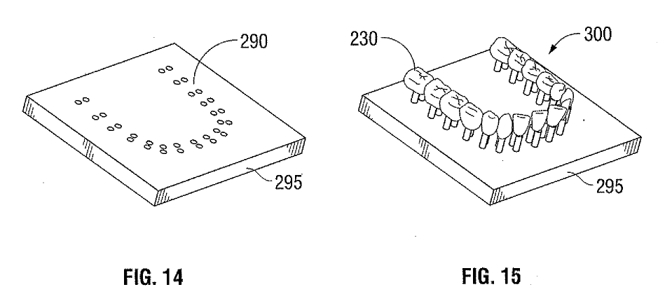

In some variations, physical tooth models are arranged to form a physical model of an arrangement of the subject's teeth to be used in fabricating a dental aligner by, for example, a pressure or vacuum forming process. This may be accomplished, for example, by methods disclosed in International Patent Application No. PCT/US2005/039715 titled “METHODS AND APPARATUSES FOR MANUFACTURING DENTAL ALIGNERS,” filed Nov. 2, 2005, which is incorporated herein by reference in its entirety. Referring to FIGS. 14 and 15, for example, sockets or other receptacles (e.g., drill holes) 290 may be formed in a base plate 295 to receive physical tooth models 230 to form a physical model 300 of an arrangement of the subject's teeth based on a digital model of the arrangement. Physical tooth models 230 may be fabricated, for example, by casting a positive mold of the subject's tooth arch from a negative impression of the tooth arch and then separating the positive mold into individual physical tooth models or physical models of groups of teeth in a manner similar or identical to that described above. Sockets 290 may be formed by methods including, but not limited to, computer numerical control based machining (e.g., drilling), laser machining, and printing or forming sockets in a soft material which is later cured or hardened. Base plate 295 may be made from materials including, but not limited to, plastics, metals, and machineable waxes. The digital model may include the positions of pins on the physical tooth models corresponding to the teeth in the digital model. Hence, the relative locations and orientations of sockets 290 may be chosen to correspond to the locations and orientations of the pins.

Pin locations in the physical tooth models and corresponding socket locations in the base plate may be chosen to avoid interference between the pins of neighboring physical tooth models. As physical tooth models 230 are placed onto base plate 295, an operator may adjust the physical tooth models (e.g., shaving, or rounding out sections of the tooth profile, etc.) to ensure that a proper fit between the physical tooth models can be achieved.

In other variations, a physical model of an arrangement of the subject's teeth is fabricated by computer numerical controlled manufacturing based on a digital model of the arrangement, and then used to fabricate a dental aligner by, for example, a pressure or vacuum forming process.

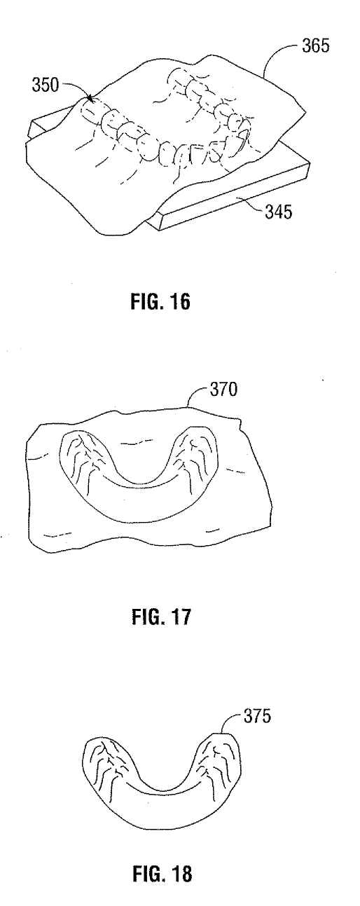

Referring now to FIG. 16, in one variation, a sheet of aligner material 365 is placed over a physical model 350 of an arrangement of a subject's teeth arranged or formed on a base plate 345 by, for example, any of the methods described above. Sheet 365 is heated and then vacuum formed around physical model 350 by, for example, a vacuum pump that removes air at the bottom of base plate 345 to cause the softened aligner material 365 to fittingly form around physical model 350. Suitable aligner materials include but are not limited to polymers known to one of ordinary skill in the art. In some variations, gaps or voids between teeth in the physical model are filled before the aligner is vacuum formed so that the aligner may be more easily removed from the dental arch at the conclusion of the vacuum forming process.

As shown in FIG. 17, vacuum-formed sheet 370 of aligner material maybe removed from physical model 350 after it has sufficiently cooled. Excess materials on the vacuum-formed polymeric sheet 370 may then be trimmed off to form a polymeric shell 375 that can serve as a removable aligner, as shown in FIG. 18.

In other variations, a digital model of a dental aligner is generated from a digital model of an arrangement of the subject's teeth. The digital model of the arrangement of the subject's teeth may be, for example, a digital model of a modified arrangement of the subject's teeth generated in step 120, or a digital model of an intermediate arrangement of the subject's teeth generated from or by visual reference to a digital model of a modified arrangement generated in step 120. A physical dental aligner is then manufactured from the digital model of the dental aligner using, for example, computer numerical control based manufacturing techniques.

Examples and variations of another exemplary process for fabricating dental aligners, similar to that shown in FIG. 4, are also disclosed herein. In this exemplary process, a first three-dimensional digital model of an arrangement of a subject's teeth is viewed stereoscopically, one or more teeth in the first digital model are manipulated to generate a second three-dimensional model of a modified arrangement of the subject's teeth, and one or more dental aligners configured to reposition the subject's teeth into the modified arrangement are then fabricated.

The first digital model maybe, for example, a three-dimensional model of a current arrangement of the subject's teeth acquired, for example, by any of the methods described above. Alternatively, the first digital model may be a three-dimensional model of a modified arrangement of the subject's teeth generated, for example, by any of the methods described above. The digital models may be stereoscopically viewed by any of the methods disclosed above, for example. Teeth in the digital models may be manipulated, for example, by instructing a computer via a conventional keyboard, via a conventional mouse, via hand gestures as disclosed above, or by any suitable combination of these methods. The one or more dental aligners may be fabricated by any of the methods disclosed above.

This invention has been described and specific examples of the invention have been portrayed. While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention which are within the spirit of the disclosure or equivalent to the inventions found in the claims, it is the intent that this patent will cover those variations as well. Finally, all publications and patent applications cited in this specification are herein incorporated by reference in their entirety as if each individual publication or patent application were specifically and individually put forth herein.

What is claimed is:

1. A method for visualizing and manipulating a three-dimensional digital dental model, the method comprising:
viewing the three-dimensional digital dental model; and
using hand gestures to instruct a computer to manipulate one or more teeth in the digital dental model.

2. The method of claim 1, wherein the digital dental model comprises a digital model of a subject's tooth arch.

3. The method of claim 1, wherein manipulating one or more teeth in the digital dental model comprises rotating, translating, or rotating and translating one or more teeth in the digital dental model.

4. The method of claim 1, wherein a user selects a tooth movement with a gesture made with one hand and controls an extent of the movement with a gesture made with the other hand.

5. The method of claim 1, wherein using hand gestures comprises instructing the computer via at least one data glove that measures orientations, positions, or movements, or a combination thereof, of a user's fingers.

6. The method of claim 1, wherein using hand gestures comprises instructing the computer via at least one three-dimensional position sensing device that measures the three-dimensional position, or a change in the three-dimensional position, of at least one of a user's hands.

7. The method of claim 1, wherein using hand gestures comprises instructing the computer via at least one data glove that measures orientations, positions, or movements, or a combination thereof, of a user's fingers and at least one three-dimensional position sensing device that measures the three-dimensional position, or a change in the three-dimensional position, of at least one of the user's hands.

8. The method of claim 1, wherein manipulating the one or more teeth in the digital dental model comprises a user receiving force feedback relating to the forces necessary to manipulate one or more corresponding teeth in a subject's mouth in the same manner.

9. The method of claim 1, wherein
using hand gestures comprises instructing the computer via at least one data glove that measures orientations, positions, or movements, or a combination thereof, of a user's fingers and at least one three-dimensional position sensing device that measures the position, or a change in the position, of at least one of the user's hands; and
the user receives force feedback relating to the forces necessary to manipulate one or more corresponding teeth in a subject's mouth in the same manner.

10. The method of claim 1, wherein viewing comprises stereoscopically viewing the digital dental model.

11. The method of claim 10, wherein stereoscopically viewing the digital dental model comprises viewing left-eye and right-eye images of the digital dental model presented on a same screen through a stereoscopic viewing device that transmits left-eye images to a user's left eye, transmits right-eye images to the user's right eye, blocks left-eye images from the user's right eye, and blocks right-eye images from the user's left eye.

12. The method of claim 10, wherein stereoscopically viewing the digital dental model comprises viewing different images presented directly to a user's left and right eyes.

13. The method of claim 10, wherein using hand gestures comprises instructing the computer via at least one data glove that measures orientations, positions, movements, or a combination thereof, of a user's fingers.

14. The method of claim 10, wherein using hand gestures comprises instructing the computer via at least one three-dimensional position sensing device that measures the three-dimensional position, or a change in the three-dimensional position, of at least one of a user's hands.

15. The method of claim 10, wherein using hand gestures comprises instructing the computer via at least one data glove that measures orientations, positions, movements, or a combination thereof, of a user's fingers and at least one three-dimensional position sensing device that measures the three-dimensional position, or a change in the three-dimensional position, of at least one of the user's hands.

16. The method of claim 10, wherein manipulating the one or more teeth in the digital dental model comprises a user receiving force feedback relating to the forces necessary to manipulate one or more corresponding teeth in a subject's mouth in the same manner.

17. The method of claim 10, wherein
the hand gestures are detected by at least one data glove that measures orientations, positions, movements, or a combination thereof, of a user's fingers and by at least one three-dimensional position sensing device that measures the three-dimensional position, or a change in the three-dimensional position, of at least one of the user's hands; and
the user receives force feedback relating to the forces necessary to manipulate one or more corresponding teeth in a subject's mouth in the same manner.

18. A dental treatment method comprising:
acquiring a three-dimensional digital model of a current arrangement of a subject's teeth;
viewing the three-dimensional digital model of the current arrangement;
using hand gestures to instruct a computer to manipulate one or more teeth in the digital model of the current arrangement to generate a three-dimensional digital model of a modified arrangement of the subject's teeth; and
fabricating one or more dental aligners configured to reposition the subject's teeth into the modified arrangement.

19. The method of claim 18, wherein acquiring the digital model of the current arrangement comprises digitizing at least one of: the subject's tooth arch, a negative impression of the subject's tooth arch, and a positive model of the subject's tooth arch.

20. The method of claim 18, wherein acquiring the digital model of the current arrangement comprise acquiring images of at least one of: the subject's tooth arch, a negative impression of the tooth arch, and a positive model of the tooth arch.

21. The method of claim 18, wherein acquiring the digital model of the current arrangement comprises:
acquiring a negative impression of the subject's tooth arch;
casting a positive model of the tooth arch from the negative impression; separating the positive model into the plurality of physical tooth models;
generating a plurality of digital tooth models from the plurality of physical tooth models;and
generating the digital model of the current arrangement from the digital tooth models.

22. The method of claim 18, wherein viewing comprises stereoscopically viewing the digital model of the current arrangement.

23. The method of claim 18, wherein using hand gestures comprises instructing the computer via at least one data glove that measures orientations, positions, movements, or a combination thereof, of a user's fingers.

24. The method of claim 18, wherein using hand gestures comprises instructing the computer via at least one three-dimensional position sensing device that measures the three-dimensional position, or a change in the three-dimensional position, of at least one of a user's hands.

25. The method of claim 18, wherein manipulating the one or more teeth in the digital dental model comprises a user receiving force feedback relating to the forces necessary to manipulate one or more corresponding teeth in a subject's mouth in the same manner.

26. The method of claim 18, wherein fabricating one or more dental aligners comprises: arranging a plurality of physical tooth models to form a physical model of the modified arrangement; and forming a dental aligner over the physical model of the modified arrangement.

27. The method of claim 18, wherein fabricating one or more dental aligners comprises:
manufacturing a physical model of the modified arrangement by computer numerical controlled manufacturing based on the digital model of the modified arrangement; and
forming a dental aligner over the physical model of the modified arrangement.

28. The method of claim 18, wherein fabricating one or more dental aligners comprises:
generating a digital model of a dental aligner from the digital model of the modified arrangement; and
manufacturing a dental aligner by computer numerical control manufacturing based on the digital model of a dental aligner.

29. The method of claim 18, wherein fabricating one or more dental aligners comprises;
generating one or more digital models of intermediate arrangements of the subject's teeth from the digital model of the current arrangement and the digital model of the modified arrangement, wherein the one or more intermediate arrangements are intermediate between the current arrangement and the modified arrangement in a dental treatment; and
fabricating the one or more dental aligners from the one or more digital models of intermediate arrangements.

30. A dental treatment method comprising:
stereoscopically viewing a three-dimensional digital model of an arrangement of a subject's teeth;
manipulating one or more teeth in the digital model to generate a three-dimensional digital model of a modified arrangement of the subject's teeth; and
fabricating one or more dental aligners to reposition the subject's teeth into the modified arrangement.

31. The method of claim 30, wherein manipulating one or more teeth comprises using hand gestures to instruct a computer to manipulate the one or more teeth.

32. The method of claim 30, wherein manipulating one or more teeth comprises using a conventional keyboard to instruct a computer to manipulate the one or more teeth.
